(19) United States
(12) Patent Application Publication
(10) Pub. No.: US 2025/0046331 A1
(43) Pub. Date: Feb. 6, 2025

(54) VISUAL REPRESENTATION OF TEXT ON VOICE MODULATION GRAPH

(71) Applicant: Cisco Technology, Inc., San Jose, CA (US)

(72) Inventor: Manish Hans, Bangalore (IN)

(21) Appl. No.: 18/363,101

(22) Filed: Aug. 1, 2023

(51) Int. Cl. G10L 21/10; G06F 3/0484; G10L 15/06; G10L 15/26

(52) U.S. Cl. CPC G10L 21/10; G06F 3/0484; G10L 15/063; G10L 15/26; G06F 3/0482

(57) ABSTRACT

Presented herein are techniques to display text of words spoken within a modulation graph representative of audio of the words. A method includes obtaining audio that includes words spoken by a user and generating a modulation graph representative of the audio. Text of the words spoken by the user is obtained from the audio and the text of the words is displayed within the modulation graph of the audio so the words are displayed at a location within the modulation graph that corresponds to the audio of the words being spoken. An input is received from the user to perform one or more actions with respect to the modulation graph and the one or more actions based on the input is performed.

### TECHNICAL FIELD

The present disclosure relates to displaying text of spoken words within a modulation graph of audio of the spoken words.

### BACKGROUND

A signal modulation graph may present text as voice signals in a graphical user interface (GUI). There are many editors that translate text-to-voice or voice-to-text. A user may use tools to edit or mix audio files illustrated as signal modulation graphs. However, the user cannot view text of the audio being spoken when editing the signal modulation graph. Instead, the user may listen to the audio when editing the signal modulation graph.

### BRIEF DESCRIPTION OF THE DRAWINGS

FIG. 1 is an example graphical user interface illustrating a signal modulation graph with text of the audio and options for editing the signal modulation graph, according to an example embodiment.

FIG. 2 is an example signal modulation graph with text of the audio within the signal modulation graph, according to an example embodiment.

FIG. 3 is an example signal modulation graph with text of the noise of the audio within the signal modulation graph, according to an example embodiment.

FIG. 4 is an example signal modulation graph with text of a non-native language audio within the signal modulation graph, according to an example embodiment.

FIG. 5 is a flow chart of illustrating a method for displaying text of audio within a signal modulation graph of the audio and performing actions with respect to the signal modulation graph, according to an example embodiment.

FIG. 6 is a block diagram of a device configured to perform the techniques described herein, according to an example embodiment.

### DESCRIPTION OF EMBODIMENTS

### Overview

Presented herein are techniques to display text of words spoken by a user in a modulation graph representative of audio of the words spoken by the user. A method includes obtaining audio that includes words spoken by a user; generating a modulation graph representative of the audio; obtaining text of the words spoken by the user from the audio; displaying the text of the words within the modulation graph of the audio so the words are displayed at a location within the modulation graph that corresponds to the audio of the words being spoken; receiving an input from the user to perform one or more actions with respect to the modulation graph; and performing the one or more actions based on the input.

Embodiments described herein enhance the user experience of collaboration applications by transcribing online meetings or collaboration sessions, presenting the text of the transcription within a modulation graph of the audio of the online meeting/collaboration session, and performing one or more actions with respect to the audio based on a user input. Embodiments described herein provide a useful feature to improve accessibility by providing text visualization of the audio within the voice modulation graph. In this way, hearing impaired users may be able to edit the audio by viewing the words spoken and without having to listen to the audio.

In addition, providing the visual texts within the modulation graph may help in improving the audio output quality by addressing issues like noises, stuttering, and unwanted pauses. The text-enhanced voice modulation graph provides visual cues to take instant actions, such as editing the graph to delete unwanted noises in the audio. Embodiments described herein help the user to visualize pauses, white noise, and stuttering in the voice while providing real-time stuttering instances via a GUI and options to remove unwanted noises in the transcript. In addition, providing the real-time stuttering via the GUI may allow for later training to be provided to users on how to improve their voice quality.

Embodiments described herein illustrate the text as word or text bubbles within a voice modulation graph representative of audio of the words. The text bubbles are presented as waves within the waves of the voice modulation graph at a point at which the text was spoken. In other words, the letters and sounds that make up the words are placed in the voice modulation graph at a location that corresponds to a time when the letters and sounds were spoken in the audio. The shapes of the letters and sounds in the word bubbles correspond to the shapes of the voice modulation graph so that the height and width of the letters illustrate the stress or pitch of the letters or sounds in the word. In other words, because the size and shape of the letters in the text of the words are matched with the audio of the voice modulation graph, the intonation of the text may be identified based on the height and width of letters in the words. Providing the word bubbles within the voice modulation graph may provide for ease of identifying the words and ease of identifying the stress on particular words/sounds/syllables, may illustrate a visual pattern (e.g., of words, sounds, stresses, etc.), and may provide much needed accessibility on voice and audio editing tools (e.g., by allowing hearing impaired users to edit audio).

Providing the text within the modulation graph may provide a better understanding of pitch and intonations, which may help in training machine learning (ML) models to learn different dialects, sounds, and patterns. Through visual representation of text on modulation graphs, an ML model may learn to create better and more useful text outputs (e.g., minutes of a meeting, transcripts, etc.). According to embodiments described herein, a ML model may additionally be trained to remove unwanted noises (e.g., white noise, stuttering, stammering, etc.) in audio in real-time or after audio has been recorded. For example, a ML may be trained to identify unwanted noises (e.g., by visually identifying the unwanted noises) based on a user removing the unwanted noises or marking unwanted noises in previous voice modulation graphs. Based on the training, the ML model may remove unwanted noise in real-time (e.g., during online meetings or videoconferences) or prior to providing the audio to a user (e.g., at the conclusion of an online meeting or videoconference).

### EXAMPLE EMBODIMENTS

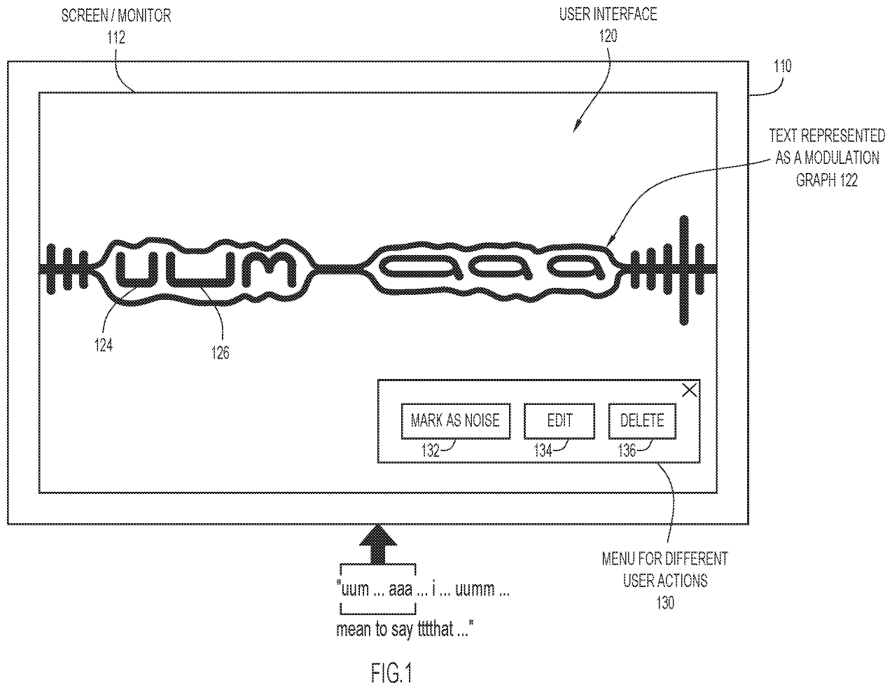

Reference is now made to FIG. 1. FIG. 1 shows a device 110 with a screen/monitor 112 displaying a GUI or user interface 120. User interface 120 is displaying a text-enhanced modulation graph 122 and a menu 130 with options for actions to perform with respect to the text-enhanced modulation graph 122. Menu 130 includes a mark as noise option 132, an edit option 134, and a delete option 136.

In the example illustrated in FIG. 1, a user has recorded speech and is using a voice/text editor application to view text of the speech within a modulation graph. For example, the speech may be speech from a presentation, an online meeting, a voice memo, etc. In this example, the user is saying “umm . . . aaa . . . I . . . uumm . . . mean to say tttthat . . . ” The user may be editing the audio to, for example, remove the stammering “uumm . . . aaa . . . ” User interface 120 is displaying text-enhanced modulation graph 122 with the words/sounds “uum” and “aaa” within the modulation graph. The text or word bubbles corresponding to the words/sounds “uum” and “aaa” are inserted into the modulation graph at a location that corresponds to the time when the words/sounds “uum” and “aaa” were spoken.

The modulation graph illustrates properties of the corresponding audio that is represented by the modulation graph. For example, a volume, emphasis, pitch, etc. of the sounds in the audio may be identified based on the amplitude, frequency, etc. of the representative modulation graph. In the text-enhanced modulation graph 122, the height and width of the letters in the text follow the wave of the corresponding modulation graph. In one embodiment, the height of the letters may illustrate a pitch of the corresponding sound and the width of the letters may correspond to the stress of the sounds/words in the sound bubbles. In the example illustrated in FIG. 1, the first letter “u” 124 is narrower than the second letter “u” 126. In this example, the user has put more stress on the second letter “u” 126. For example, the user may have elongated the sound of the second letter “u” 126 when speaking.

User interface 120 includes a menu 130 with options for editing the audio. Because the text of the words within audio is illustrated within the modulation graph, the user may edit the audio without listening to the audio. Mark as noise option 132 allows the user to mark particular sounds as noise. This option may be useful for training a ML model to remove unwanted noise in subsequent audio. Edit option 134 allows the user to edit parts of the audio (e.g., change properties of the audio, mix audio, add additional audio to the audio, change a speed of the audio, etc.). Delete option 136 allows the user to delete a portion of the audio. For example, the user may want to remove unwanted sounds (e.g., white noise, stammering, etc.). Displaying the text of the audio in the modulation graph allows the user to quickly and easily remove unwanted noise or speech without having to listen to the audio.

An artificial intelligence (AI) or ML model associated with an audio editing application or a collaboration application (e.g., an application that hosts online meetings or collaboration sessions) with audio editing tools may be trained to automatically edit audio based on the user's actions. For example, the ML model may visually identify the words/sounds that the user has marked as noise (e.g., by choosing mark as noise option 132) or deleted (e.g., by choosing the delete option 136) in a number of audio recordings. The ML model may be trained based on visually identifying the same or similar words/sounds to automatically delete unwanted sounds in subsequent audio. In some embodiment, the ML model may remove the unwanted sounds in real-time. For example, the ML model may remove the unwanted sounds spoken by a user in an online meeting before the user's audio is transmitted to other participants in the online meeting. In another embodiment, the ML model may remove the unwanted sounds before storing or presenting the audio. For example, the ML model may automatically remove the unwanted sounds at the conclusion of a meeting, before storing the audio, or alerting the user that the audio is available.

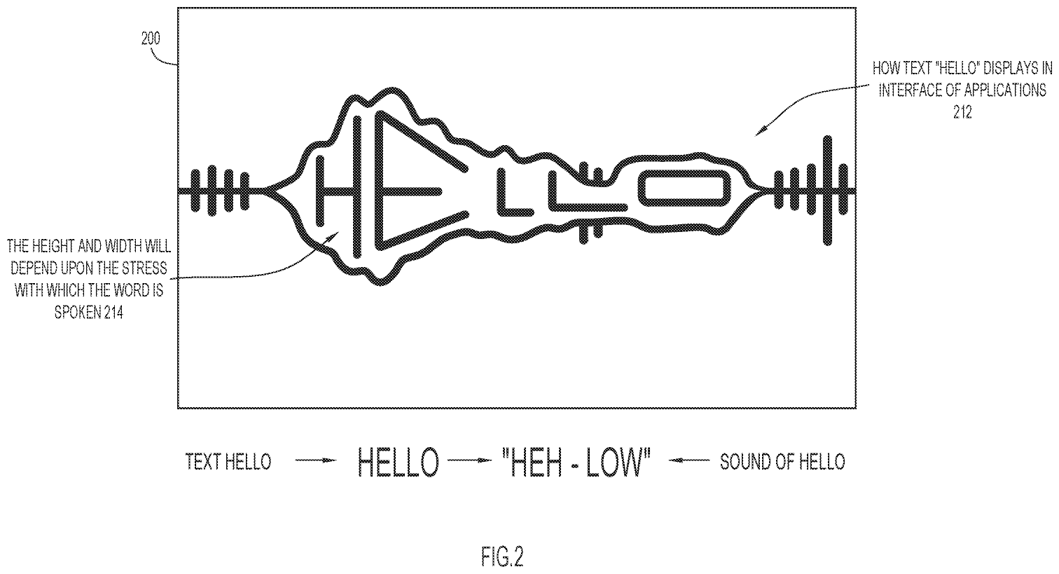

Reference is now made to FIG. 2. FIG. 2 is a user interface 200 illustrating a text-enhanced voice modulation graph 212 illustrating how the word “hello” is displayed.

As illustrated at 214 of FIG. 2, the height and width the letters in the word “hello” vary and correspond to the wave of the voice modulation graph. For example, the “H” and the “E” are taller than the “LLO” and the height of the letters change as the amplitude of the voice modulation graph changes. The height of the letters may, for example, indicate a pitch with which the corresponding sounds are pronounced in the audio. In addition, the width of the “O” at the end of the word indicates a stress placed on the final letter in the audio. As discussed earlier, the text of the word “HELLO” is inserted into the voice modulation graph at the corresponding location in the audio where the word “hello” is spoken. Because the amplitude of the voice modulation graph changes based on the stress with which the words are spoken, the height and width of the letters will also vary based on the stress or pitch with which the word or sounds within the word are spoken.

The intonation and pronunciation of the word may be identified based on the height and width of the letters in the word. For example, it may be possible to determine where to put a stress in the word based on the height and width of the letters. Based on the text-enhanced voice modulation graph 212, a user may identify that the text “HELLO” sounds like “HEH-LOW.” By placing the text of the words and sounds of the audio within the voice modulation graph of the audio, a user may easily identify the words spoken in the audio and may identify which words or syllables are stressed based on the height and width of the letters within the words.

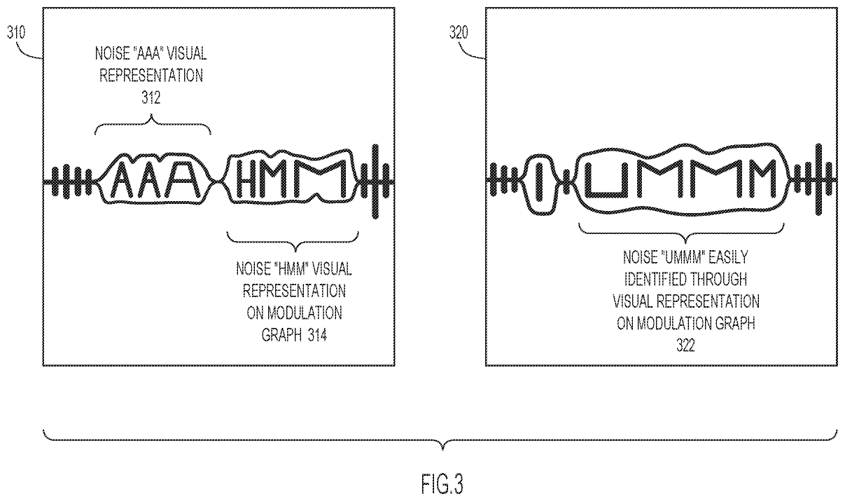

Reference is now made to FIG. 3. FIG. 3 illustrates an example in which a hearing-impaired user is able to edit audio using a text-enhanced voice modulation graph of the audio. FIG. 3 illustrates a user interface 310 that includes a voice modulation graph with the words/sounds “aaa hmmm” and a user interface 320 that includes a voice modulation graph with the words/sounds “I ummm.”

In this example, the user has a hearing impairment and the user is unable to hear voices or sounds. Assume the user works in a marketing department and frequently edits videos. In this example, the user edits videos using a video editor application that has an accessibility feature that allows the user to view the text of the audio within the modulation graph. For example, when the user chooses an option to use the accessibility feature, the text of the audio is shown within the modulation graph. The video editor application may additionally provide a menu (such as menu 130 illustrated in FIG. 1) to allow the user to edit the audio by viewing the text of the audio within the modulation graph.

By viewing the text of the audio within the modulation graph, the user is able to identify unwanted noises/sounds within the audio and perform an action with regard to the unwanted noises/sounds. For example, as shown at 312, the user may identify a visual representation of the sound/noise “aaa” and, as shown at 314, the user may identify the visual representation of the sound/noise “hmm” on the modulation graph. As shown at 322, the user may identify an unwanted noise “ummm” through visual representation of the noise on the modulation graph. The user may choose an option to mark these sounds/noises as unwanted or to delete these sounds/noises from the audio. In some embodiments, a ML model may be trained based on the user's selections to visually identify unwanted noises/sounds in subsequent audio and remove the unwanted noises/sounds in the subsequent audio.

The user may additionally be able to identify how to pronounce the words with the correct stress on certain words, sounds, or syllables using the text-enhanced modulation graph. For example, the height and width of the letters in the text of the audio may indicate where the stress is placed on the words. The pitch of the letters or sounds may also be identified based on the height and width of the letters in the text. In this example, although the user may be unable to hear the speech in the audio, the user may be able to identify how the words are pronounced and edit the audio to, for example, delete unwanted noises/sounds.

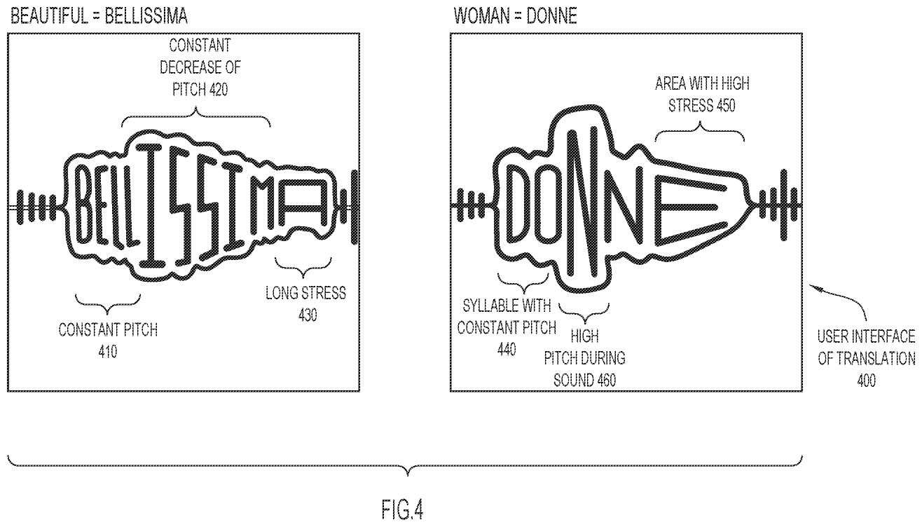

Reference is now made to FIG. 4. FIG. 4 shows a user interface 400 illustrating a text-enhanced modulation graph generated in response to a user querying how to say a word or phrase in a non-native language.

In the example illustrated in FIG. 4, the user wants to hear and understand how to pronounce “beautiful woman” in the Italian language. In this example, the user may open a translator application and query how to say “beautiful woman” in the Italian language. The translator application may include an option to view the translation in a modulation graph. The user may choose the option to view the translation in a modulation graph and user interface 400 may display a modulation graph with the words “bellissima donne,” which is Italian for “beautiful woman.” The height and width of the letters in the modulation graph indicate the stress and pitch with which different sounds are to be pronounced.

As illustrated at 410, the constant height of the letters indicate that the pitch is constant over the letters “BELL” in “bellissima.” As shown at 420, the increase in size of the letter “I” followed by a decrease in size of the letters “SSIM” indicate a sharp increase in pitch followed by a constant decrease in the pitch. As shown at 430, the width of the “A” at the end of “bellissima” indicates a long stress at the end of the word.

As illustrated at 440, the constant height of the “DO” in “donne” indicates a syllable with a constant pitch. As shown at 450, the increase in height of the letter “N” indicates a high pitch during the sound. As shown at 460, the width of the letter “E” indicates an area of high stress at the end of the word “donne.”

By illustrating a word or words in a modulation graph, a user may be able to identify the stress and pitch with which different sounds in the words are to be pronounced. In this way, a user may have a better understanding of how to pronounce non-native words than if the user is merely shown the text of the words.

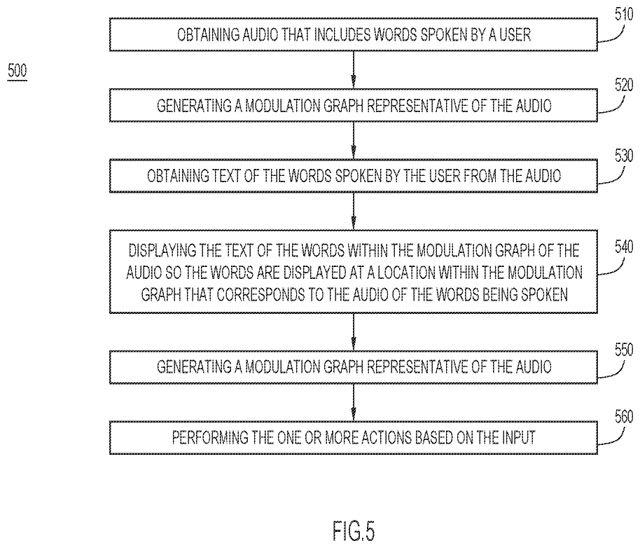

FIG. 5 is a flow chart illustrating a computer-implemented method 500 for displaying text of words within a modulation graph of audio of the words. The method may be performed by a device, such as device 110. In some embodiments, the method may be performed by an application (e.g., an audio editor, a collaboration application, etc.) running on the device.

At 510, audio that includes words spoken by a user may be obtained. For example, audio from an online meeting, a presentation, or other audio including words spoken by the user may be obtained. At 520, a modulation graph representative of the audio may be generated. At 530, text of the words spoken by the user from the audio may be obtained. For example, the text of the audio may be transcribed (e.g., by the application running on the device).

At 540, the text of the words within the modulation graph of the audio may be displayed so the words are displayed at a location within the modulation graph that corresponds to the audio of the words being spoken. The height and width of the letters within the text may vary based on the pitch or stress of the letters or syllables in the corresponding audio of the words or sounds. The height and width of the letters may correspond to the wave of the modulation graph.

At 550, an input to perform one or more actions with respect to the modulation graph may be received from the user. For example, the user may select an option to mark portions of the audio as noise, an option to edit the audio, an option to delete a portion of the audio, or another option. At 560, the one or more actions may be performed based on the input. For example, the portions of the audio may be marked as noise, the audio may be edited, a portion of the audio may be deleted, or another action may be performed.

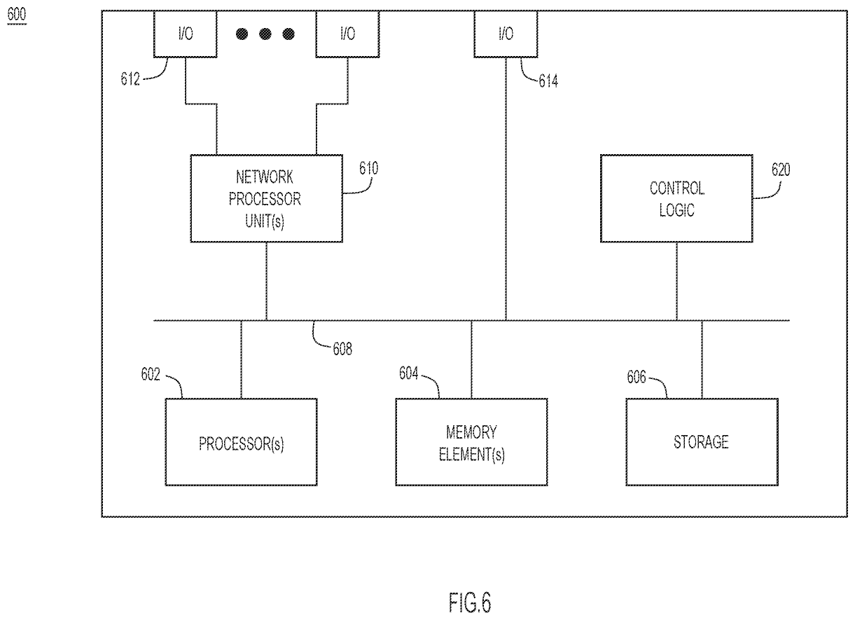

Reference is now made to FIG. 6. FIG. 6 is a block diagram of a device that may be configured to operate as device 110 or another device described herein and perform the techniques described herein, according to an example embodiment.

In various embodiments, a computing device, such as computing device 600 or any combination of computing devices 600, may be configured as any entity/entities as discussed for the techniques depicted in connection with FIGS. 1-5 in order to perform operations of the various techniques discussed herein.

In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form a computer-implemented method is provided including: obtaining audio that includes words spoken by a user; generating a modulation graph representative of the audio; obtaining text of the words spoken by the user from the audio; displaying the text of the words within the modulation graph of the audio so the words are displayed at a location within the modulation graph that corresponds to the audio of the words being spoken; receiving an input from the user to perform one or more actions with respect to the modulation graph; and performing the one or more actions based on the input.

In one example, a height or width of letters of the text of the words displayed within the modulation graph indicates a stress or pitch with which the words or syllables within the words are spoken. In another example, displaying includes displaying the text of the words within the modulation graph on a user interface that includes options for selecting the one or more actions to perform. In another example, the one or more actions include marking noise in the audio, editing the audio, and deleting a portion of the audio.

In another example, the input includes a selection to remove identified sounds in the audio, and the method further includes: training a machine learning model based on the input to remove the identified sounds in subsequently obtained audio. In another example, the modulation graph displays a stress or a pitch of words in a plurality of languages. In another example, the method further includes training a machine learning model using the modulation graph to learn different dialects, sounds, and patterns.

In another form, a device is provided including: a memory; and one or more processors coupled to the memory, and configured to: obtain audio that includes words spoken by a user; generate a modulation graph representative of the audio; obtain text of the words spoken by the user from the audio; display the text of the words within the modulation graph of the audio so the words are displayed at a location within the modulation graph that corresponds to the audio of the words being spoken; receive an input from the user to perform one or more actions with respect to the modulation graph; and perform the one or more actions based on the input.

In yet another form, one or more non-transitory computer readable storage media encoded with instructions are provided that, when executed by one or more processors, cause the one or more processors to: obtain audio that includes words spoken by a user; generate a modulation graph representative of the audio; obtain text of the words spoken by the user from the audio; display the text of the words within the modulation graph of the audio so the words are displayed at a location within the modulation graph that corresponds to the audio of the words being spoken; receive an input from the user to perform one or more actions with respect to the modulation graph; and perform the one or more actions based on the input.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining audio that includes words spoken by a user;
generating a modulation graph representative of the audio;
obtaining text of the words spoken by the user from the audio;
displaying the text of the words within the modulation graph of the audio so the words are displayed at a location within the modulation graph that corresponds to the audio of the words being spoken;
receiving an input from the user to perform one or more actions with respect to the modulation graph; and
performing the one or more actions based on the input.

2. The computer-implemented method of claim 1, wherein a height or width of letters of the text of the words displayed within the modulation graph indicates a stress or pitch with which the words or syllables within the words are spoken.

3. The computer-implemented method of claim 1, wherein displaying includes displaying the text of the words within the modulation graph on a user interface that includes options for selecting the one or more actions to perform.

4. The computer-implemented method of claim 1, wherein the one or more actions include marking noise in the audio, editing the audio, and deleting a portion of the audio.

5. The computer-implemented method of claim 1, wherein the input includes a selection to remove identified sounds in the audio, and further comprising:
training a machine learning model based on the input to remove the identified sounds in subsequently obtained audio.

6. The computer-implemented method of claim 1, wherein the modulation graph displays a stress or a pitch of words in a plurality of languages.

7. The computer-implemented method of claim 1, further comprising:
training a machine learning model using the modulation graph to learn different dialects, sounds, and patterns.

8. A device comprising:
a memory; and
one or more processors coupled to the memory, and configured to:
obtain audio that includes words spoken by a user;
generate a modulation graph representative of the audio;
obtain text of the words spoken by the user from the audio;
display the text of the words within the modulation graph of the audio so the words are displayed at a location within the modulation graph that corresponds to the audio of the words being spoken;
receive an input from the user to perform one or more actions with respect to the modulation graph; and
perform the one or more actions based on the input.

9. The device of claim 8, wherein a height or width of letters of the text of the words displayed within the modulation graph indicates a stress or pitch with which the words or syllables within the words are spoken.

10. The device of claim 8, wherein, when displaying, the one or more processors are configured to display the text of the words within the modulation graph on a user interface that includes options for selecting the one or more actions to perform.

11. The device of claim 8, wherein the one or more actions include marking noise in the audio, editing the audio, and deleting a portion of the audio.

12. The device of claim 8, wherein the input includes a selection to remove identified sounds in the audio, and wherein the one or more processors are further configured to:
train a machine learning model based on the input to remove the identified sounds in subsequently obtained audio.

13. The device of claim 8, wherein the modulation graph displays a stress or a pitch of words in a plurality of languages.

14. The device of claim 8, wherein the one or more processors are further configured to training a machine learning model using the modulation graph to learn different dialects, sounds, and patterns.

15. One or more non-transitory computer readable storage media encoded with instructions that, when executed by one or more processors, cause the one or more processors to:
obtain audio that includes words spoken by a user;
generate a modulation graph representative of the audio;
obtain text of the words spoken by the user from the audio;
display the text of the words within the modulation graph of the audio so the words are displayed at a location within the modulation graph that corresponds to the audio of the words being spoken;
receive an input from the user to perform one or more actions with respect to the modulation graph; and
perform the one or more actions based on the input.

16. The one or more non-transitory computer readable storage media of claim 15, wherein a height or width of letters of the text of the words displayed within the modulation graph indicates a stress or pitch with which the words or syllables within the words are spoken.

17. The one or more non-transitory computer readable storage media of claim 15, when displaying, the instructions cause the one or more processors to display the text of the words within the modulation graph on a user interface that includes options for selecting the one or more actions to perform.

18. The one or more non-transitory computer readable storage media of claim 15, wherein the one or more actions include marking noise in the audio, editing the audio, and deleting a portion of the audio.

19. The one or more non-transitory computer readable storage media of claim 15, wherein the input includes a selection to remove identified sounds in the audio, and wherein the instructions further cause the one or more processors to:
train a machine learning model based on the input to remove the identified sounds in subsequently obtained audio.

20. The one or more non-transitory computer readable storage media of claim 15, wherein the modulation graph displays a stress or a pitch of words in a plurality of languages.
